(19) United States
(12) Patent Application Publication
(10) Pub. No.: US 2010/0034452 A1
(43) Pub. Date: Feb. 11, 2010

(54) Method And Apparatus For Reconstructing Solder Joints Using Constrained X-ray Photogrammetry

(76) Inventor: David L. Gines, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/188,809

(22) Filed: Aug. 8, 2008

(51) Int. Cl. G06K 9/00

(52) U.S. Cl. 382/132; 382/150

(57) ABSTRACT

A photogrammetry system is provided, for examining a feature of interest of a workpiece, the feature of interest having a first constraint. The system comprises a library of constraints, including the known constraint of the feature of interest, a scanner for scanning the workpiece to obtain a scan of the feature of interest, a selector for selecting the one of the set of constraints from the library; and an analyzer, coupled to receive the scan of the feature from the scanner and to receive the one of the set of constraints from the selector, the analyzer including a processor for performing an analysis of the scan and the first constraint, to produce an examination result for the feature of interest.

### BACKGROUND OF THE INVENTION

Embodiments of the present invention pertain to the three-dimensional (3D) reconstruction and modeling of objects, and have applicability, among other areas, to the 3D reconstruction of solder joints, for in-line manufacturing inspection. They pertain to the area of “inverse problems” which estimate an object's shape or characteristics from measurements or data inferred from the object.

A well-known example of such an inverse problem is a computerized axial tomography (“CAT”) scan used in the medical industry for imaging internal organs in the body. In this technology, multiple images of the region-of-interest are taken using penetrating radiation. Viewing the region from all sides (say 60 images between 0 and 360°) provides for accurate 3D reconstruction. The reconstruction is carried out on a computer using the mathematics of tomography.

A quantitative measurement of the thickness of solder joints, particularly taller solder joints such as ball-grid arrays (BGA) or plated through-holes (PTH), however, is more difficult to obtain in this manner. Two reasons why this is the case are 1) large objects absorb large amounts of signal, nearing the point of saturation; and 2) the x-ray absorption is non-linear, so that as saturation is approached, the measurement sensitivity to error grows dramatically.

Nevertheless, the thickness measurement is an important classification feature in the manufacturing process, so methods have been developed to estimate it. With BGAs, for example, the diameter of the ball can be measured, and, using a constant volume assumption, thickness can be inferred. See U.S. Pat. No. 6,847,900, “System and Method for Identifying Solder Joint Defects.”

With PTHs, a user may specify a minimally acceptable thickness, such as “50% of the board thickness”, and an image slice can be taken at that z-height to check for presence. While this is an effective process, it does not determine the actual solder thickness, and has limited z-resolution.

Another approach to measuring the thickness of taller joints, is to directly inspect the raw projection images. See, for instance, test systems designated as “2D machines,” as sold by the Dage Group, Ltd. To obtain good z-resolution, images are taken at high angles from the normal of the board surface. Such machines are not automated, however, which excludes their use directly in a manufacturing line.

### SUMMARY OF THE INVENTION

A photogrammetry system is provided, for examining a feature of interest of a workpiece, the feature of interest having a first constraint. The system comprises a library of constraints, including the known constraint of the feature of interest, a scanner for scanning the workpiece to obtain a scan of the feature of interest, a selector for selecting the one of the set of constraints from the library; and an analyzer, coupled to receive the scan of the feature from the scanner and to receive the one of the set of constraints from the selector, the analyzer including a processor for performing an analysis of the scan and the first constraint, to produce an examination result for the feature of interest.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram of a system embodying the invention.

FIGS. 2 and 3 are schematic cross-sectional diagrams of fan-beam geometric arrangements for inspecting a workpiece using incident radiation.

FIGS. 4 and 5 are schematic cross-sectional diagrams of parallel-beam geometric arrangements for inspecting a workpiece using incident radiation.

FIG. 6 is a diagram of a projection of a feature, as might be produced by a system employing a geometric arrangement as per one of FIGS. 2-5.

FIG. 7 is a schematic cross-sectional diagram of a geometric arrangement for inspecting a workpiece containing a feature that is cylindrical but with non-flat ends.

FIG. 8 is more detailed cross-sectional diagram of a feature as shown in FIG. 7.

FIGS. 9, 10, 11, and 12 are side views of features that are cylindrical, but that have various forms of ends that may or may not be flat.

FIG. 13 is a flowchart showing a method for practicing an embodiment of the invention.

### DETAILED DESCRIPTION

X-ray technology has been used to verify the integrity of solder joints during the in-line manufacturing of printed circuit boards and assemblies. In a typical inspection system, x-ray images are taken from several vantage points, and then mathematically combined, using laminography or digital tomosynthesis, to form a 2D “slice” image parallel to the surface of the board, and at a particular z-height above, on, or below the board surface.

In general, such printed circuit boards may be thought of as being disposed in an X-Y (horizontal) plane, with a Z dimension (vertical) being perpendicular to the board, such that components mounted on the board will extend into the Z (vertical) dimension. Vantage points, from which the images are taken, are also positioned in the Z dimension relative to the board. It will be understood, however, that terminology such as the coordinate dimensions, “horizontal” and “vertical”, “height”, “above” and “below”, etc., are for convenient example only, and do not limit the orientation, configuration, etc., of such boards or of systems and methods in accordance with embodiments of the present invention as described and/or claimed herein. In particular, any claim recitations including such terms and concepts, will be construed broadly, to include all other orientations, etc., that would be understood by a person of ordinary skill in the art.

The above-described approach to inspection is effective for a wide range of solder joint types. However, in conventional usage it may be less so for very thick joints, such as ball grid arrays (BGA's) or plated through-holes (PTH's), and may have reduced accuracy due to limited z-resolution.

By contrast, embodiments of the invention provide a reconstruction method which is well-suited for measuring the thickness of such joints using photogrammetry, modified by the addition of prior constraints specific to certain joint types.

### Conventional Techniques

### 1. Medical Systems

Tomography is a commonly-used method for image reconstruction in the medical imaging community. Gathering such a large number of images for circuit-board inspection, however, is not practical for three reasons. First, real-time speed constraints limit the number of images that can be gathered. Second, the tomography algorithm is computationally expensive, so speed constraints again rule it out. And third, images taken at angles near parallel to the board surface contain limited, if not corrupting information, because the x-ray signal reaches saturation after passing through many highly absorbing materials.

Photogrammetry is another method for reconstructing an object from (typically optical) images using triangulation to pinpoint the location of individual features on that object. Photogrammetry had some limited use in the medical community (see “Contour Radiography: A system for determining 3-dimensional contours of an object from its 2-dimensional images” U.S. Pat. No. 4,630,203), but was quickly overtaken by more modern technologies such as CAT scans and MRI's. There are several reasons for this, including 1) crude and/or ad-hoc algorithms resulting in limited performance, 2) reliance on manual methods, and 3) difficulty finding features. A particular feature must be identified in at least two images (stereoscopy, in the case of two images) in order for triangulation to work. With penetrating radiation such as x-ray, features are much harder to identify. The leading edges of an object, for example, disappear into the image background.

Heretofore, photogrammetry has not been applied to the 3D reconstruction of solder joints.

### 2. Conventional Printed Circuit Board Systems

In response to these concerns, laminographic systems have been developed which take images from several vantage points, and at angles near normal to the board surface. They further use an approximate reconstruction algorithm known as laminography (when done mechanically) or tomosynthesis (when done digitally). Automated 3D technologies, such as the 5DX or Medalist X6000 systems sold by Agilent Technologies, Inc., automatically locate a joint of interest, construct a 3D image representation of it, and classify it as good or bad based on various algorithms and user preferences. See, for instance, U.S. Pat. No. 7,231,013, “Precise X-Ray Inspection System Using Multiple Linear Sensors”.

The output image is a 2D “slice” image, parallel to the surface of the board, and at a particular z-height above, on, or below the board surface. Typically a single slice taken at the surface of the board (the board-surface slice, or pad slice) is used by a classification engine to screen for defects such as opens, shorts, insufficient solder thickness, etc. The thickness of smaller joints is obtained by correlating gray values in the image with known x-ray absorption rates in the material.

### THE INVENTION

Conventional methods, such as those described above, are only able to infer indirectly the thickness of tall joints, or check thickness at prescribed locations, or they rely on slow, manual operations.

Automated 3D technologies, such as Agilent Technologies, Inc.'s 5DX or Medalist X6000 system, can automatically locate a joint of interest, construct a 3D image representation of the solder joint, and classify it as good or bad based on various algorithms and user preferences.

In an embodiment of the invention, the thickness of such a joint is computed automatically and accurately in real time, despite a limited number of imaging angles. The number of required imaging angles may be reduced, if some of the object's features are constrained, or known in advance. In the inspection of printed circuit boards, certain solder joints, such as PTH joints, have shapes which are highly constrained by e.g. the through-hole, which contains most of the solder. For such joints, the photogrammetry algorithm is constrained to such a degree that it is possible to obtain accurate measurements of joint thicknesses, despite the limited number of angles found on typical laminography machines. For example, if the object is known to be a sphere, then fewer images are required than if the object was completely unknown; since the volume of a sphere is ascertainable, given only its radius or diameter.

Embodiments of the present invention perform 3D reconstruction for a large set of joint types, including ball-grid arrays (BGA) and plated through-holes (PTH). Broadly described, in an embodiment of the invention the following sub-problems are solved, for a workpiece such as a printed circuit board, having a feature under examination such as a solder joint:

1. Determining how the joint shape is constrained.

2. Incorporating this information into the reconstruction and modeling algorithm.

3. Identifying common features of the object in multiple images.

Accordingly, a photogrammetry techniques is used, while incorporating prior information to allow for fewer imaging angles. Thus, a photogrammetric technique is able to achieve the efficiency due to a reduced number of images, that would otherwise be available using a laminography technique.

In the discussion of embodiments of the invention which follows, examples will be given of printed circuit (PC) boards containing solder joints which are to be examined. The discussion which follows will focus on plated-through hole (PTH) solder joints, but other types of solder joints may also be used, such as ball-grid array (BGA) joints, “gull wing” joints, voids, and press-fit connectors. Embodiments of the invention may also be applied to automated optical inspection systems, such as the Medalist SP50 Series 3 Solder Paste Inspection (SPI) system, Medalist SJ50 Series 3, and sj5000 Automated Optical Inspection system, manufactured and sold by Agilent Technologies, Inc. More broadly, however, it will be understood that embodiments of the invention have applicability to the examination of other varieties of workpieces (the PC board being one example), and other varieties of features (the solder joints being one example) within such workpieces. For instance, a workpiece might be a composite material article of manufacture, or might comprise an active component (the feature of interest) encased within a solid matrix such as molded epoxy. Systems having the ability to make photogrammetric examinations of such encased components, etc., may also embody the invention.

### Block Diagram of an Embodiment

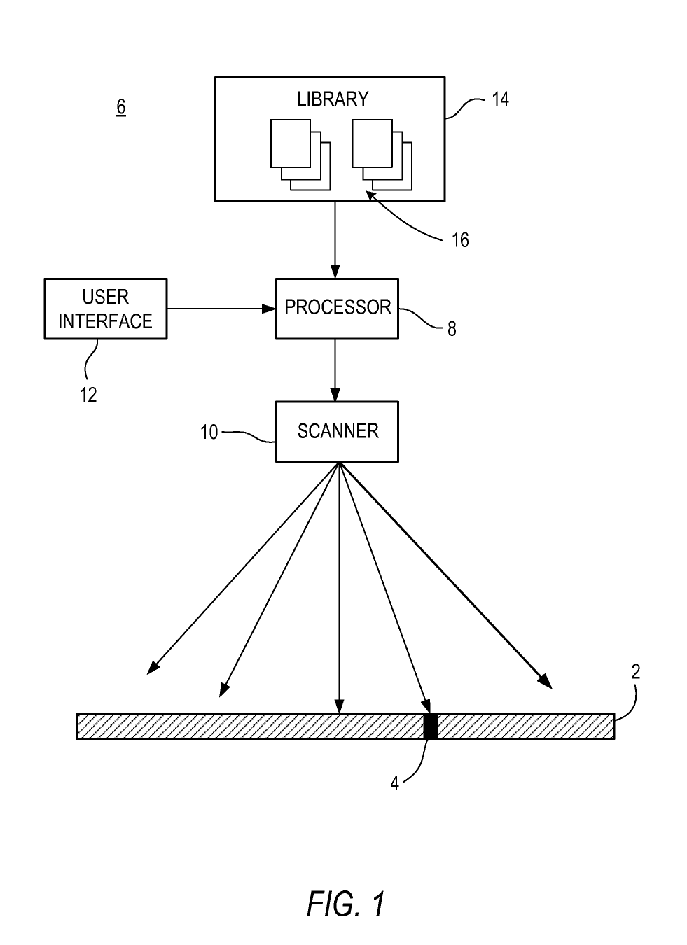

FIG. 1 is a high-level block diagram of a system embodying the invention. A workpiece 2, which includes a feature 4, is to be examined, for instance for testing purposes. In the illustrated example. the feature 4 may be a specific object of the examination. For instance, the workpiece 2 might be a printed circuit board, which is being fabricated and tested by a PC board manufacturer. The feature 4 may, for instance, be a plated-through hole, and the object of the test is to verify the structural and electrical integrity of the plated-through hole.

In a system 6 embodying the invention, a processor 8 controls a scanner 10, which performs the examination of the workpiece 2. A user interface 12 receives user input, and provides results to the user.

In an embodiment of the invention, a library 14 contains profiles 16, such as geometric profiles, which serve as constraints on characteristics, such as shapes, of features of workpieces to be examined. As one example, which will be discussed below, one of the profiles 16 might be that of a cylinder, with a circular cross-section specified by diameter, and a specified height.

Methods and apparatus embodying the invention may be applied, broadly, to the examination of any type of workpiece containing a feature of interest. Embodiments of the invention may be employed for examining printed circuit boards being manufactured, and having solder joints which require verification of their mechanical and electrical integrity. The solder joints may include any joint type whose shape is constrained in some predictable way.

The discussion which follows will focus the on the reconstruction of plated-through hold (PTH) joints, in which a cylindrical hole through the board is to be filled with solder. For such cases, the joint is constrained by the cylindrical shape of the hole, and may or may not be as clearly constrained at the circular ends of the cylinder. In an idealized situation, the ends might be exactly flush with the surfaces of the PC board, so the joint is in the exact shape of a cylinder. In a more realistic situation that might result from a manufacturing process, the ends are not necessarily flush with, or even parallel to, the surfaces of the board.

We will say, then, that a “flat cylinder” is the idealized case in which the circular faces at the ends are exactly perpendicular to the axis of the cylinder, and a “cylinder with non-flat top or bottom” is a geometric form, cylindrical on its side(s) do to the constraining shape of the plated-through hole, but not perfectly cylindrical in that the ends are not necessarily flat, perpendicular to the cylinder axis, etc. The term “barrel” will also be used, metaphorically, as a synonym for cylinder.

By convention, we will say that the board has a “top” (where electronic components are mounted) and a “bottom” (opposite to the side where the components are mounted, and where conductive leads or pins of the components, inserted through holes in the board, emerge.). However, it will be understood that this terminology is only for example and convenient understanding. It is not limiting as to physical dimensions and orientations of other types of workpieces and features to which embodiments of the invention may be applied. Where the description of the invention, and the recitations of the invention in the claims, employ such terminology, it will be understood that all variations, permutations, different orientations, different configurations, etc., that would be understood to a person of ordinary skill in the art based on this description, are included within the intended meaning of such descriptions and claim recitations.

### Simplifying Assumption: A Flat Cylinder

In an embodiment of the invention, the inverse problem may be constrained by incorporating prior information. For example, the shape of a plated-through hole (PTH) joint may be assumed to be largely cylindrical, since most of the solder is constrained by the cylindrical walls of the through-hole. Although the top and bottom caps of the joint may not be flat, we will first assume that they are, so as to simplify the algorithm description. In other embodiments to be described below, we will relax this constraint.

Broadly stated, we may say that the inner surface of the plated-through hole is a first constraint on the shape of the joint, and that the constraint is imposed on the joint by that inner PTH surface. The present simplifying assumption that the ends of the cylinder, i.e., the top and bottom caps of the joint, may broadly be described as a second constraint on the joint.

There are two geometries in reconstructive imaging: parallel beam and fan beam. In parallel beam systems, the rays travel along parallel lines; whereas in fan beam systems, the rays spread in all directions from a point source.

Embodiments of the present invention may be applied to both geometries, but the derivation is slightly different for each case. For illustration, a detailed description will now be given, for fan beam geometry.

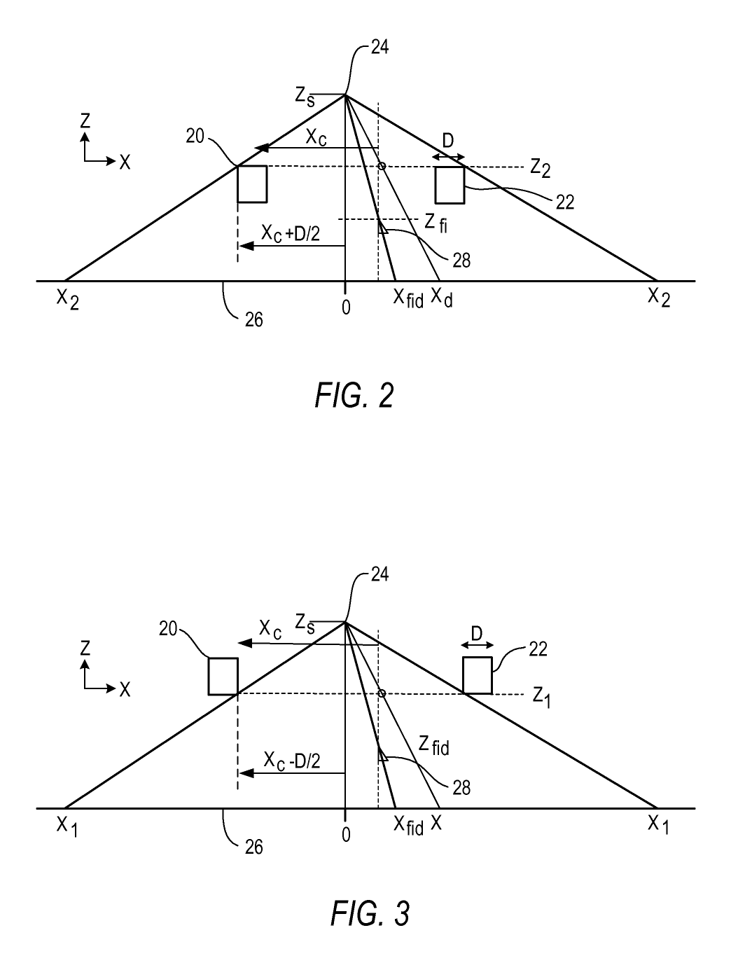

### (1) Fan Beam Geometry—FIGS. 2 AND 3

FIGS. 2 and 3 shows the cross-sectional view of the projection geometry for a fan beam system. A circuit board (not separately shown) includes first and second plated-through hole solder joints, which are illustrated, respectively, as rectangles 20 and 22. For the purpose of the present example, we make the simplifying assumption that the plated-through-hole solder joints are cylinders, whose shapes are defined by cylindrical holes through the circuit board, and whose top and bottom circular surfaces are coplanar with the top and bottom surfaces of the circuit board.

The solder joints are shown in cross-section, seen looking from the side, as the rectangles 20 and 22.

It may also be understood, equivalently, that the rectangles 20 and 22 represent a single cylindrical plated-through hole solder joint, shown being imaged at two different locations, once on the left side of the source, and once on the right of the source. In such equivalent understanding, the source stays fixed, and the circuit board moves laterally, to position the plated-through hole respectively at the positions 20 and 22. The analysis is substantially the same, either for two solder joints in a printed circuit board, or a single solder joint analyzed in two successive coplanar positions.

From a point source 24, labeled Zₛ, a beam is projected onto a flat plane 26. In a typical laminography geometry, detectors (not separately shown) lie flat on a plane (in this illustration, the plane 26) that is parallel to the circuit board.

FIG. 2 shows the measurement of the top of the joints 20 and 22, while FIG. 3 shows the measurement of the bottom of the joints 20 and 22.

The joints 20 and 22 each have a diameter D. The center of the joint 20 is located a horizontal distance x_{c} from a known reference or fiducial location, shown as a triangle 10.

Fiducial markers, also known as circuit pattern recognition marks, allow automated assembly equipment to accurately locate and place parts on boards. These equipment locate the circuit pattern by providing common measurable points. They are usually made by leaving a spot of the board bare with a bare copper-, nickel-, or solder-coated dot inside.

Referring again to FIG. 2, the fiducial reference is at a vertical height z_{fid}, with magnification Mag_{f}, and is projected to the x-location x_{fid}. The height of the joint corners are z₁ at the bottom of the joint, and z₂ at the top. The imaging ray which intersects a corner hits the detector at x₁ (bottom), or x₂ (top). The source is at a vertical height of Zₛ, and x-location 0.

An analysis of the geometry provides the relationship between the various parameters, which is given in Equations 1 and 2. Equations 1 and 2 are a linear system of equations, which can be solved for z₁, z₂, x_{c}, and D. Then, the height of the cylinder is simply h=z₂−z₁.

x₁z₁+Zₛx_{c}−Zₛ(D/2)sign(x₁)=Zₛ(x₁−x_{fid}/mag_{f}) Equation 1 (bottom, for FIG. 3)

x₂z₂+Zₛx_{c}−Zₛ(D/2)sign(x₁)=Zₛ(x₂−x_{fid}/mag_{f}) Equation 2 (top, for FIG. 2)

In solving a linear system of equations, one typically needs at least as many independent equations as there are unknowns. Each equation represents a single measurement of the object, and in many cases, there are not enough independent measurements (equations) to create a stable linear system. This means that there are many different shapes that satisfy Equations 1 and 2. However, we can further constrain the problem if the diameter of the plated-through hole solder joints is known. This leads to a new linear system given in equations 3 and 4, which is solved for z₁, z₂, and x_{c}.

x₁z₁+Zₛx_{c}=Zₛ(x₁−x_{fid}/mag_{f}+sign(x₁(D/2) Equation 3 (bottom, for FIG. 3)

x₂z₂+Zₛx_{c}=Zₛ(x₂−x_{fid}/mag_{f}+sign(x₁)D/2) Equation 4 (top, for FIG. 2)

This linear system is substantially more stable than that of Equations 1 and 2, and provides good estimates for the unknown parameters z₁, z₂, and x_{c}.

As a final note, if the part location x_{c} is also known, then the linear system decouples, and each equation may be solved independently for either z₁, or z₂, and a final estimate may be obtained through statistical combinations such as the mean, median, min, max, etc.

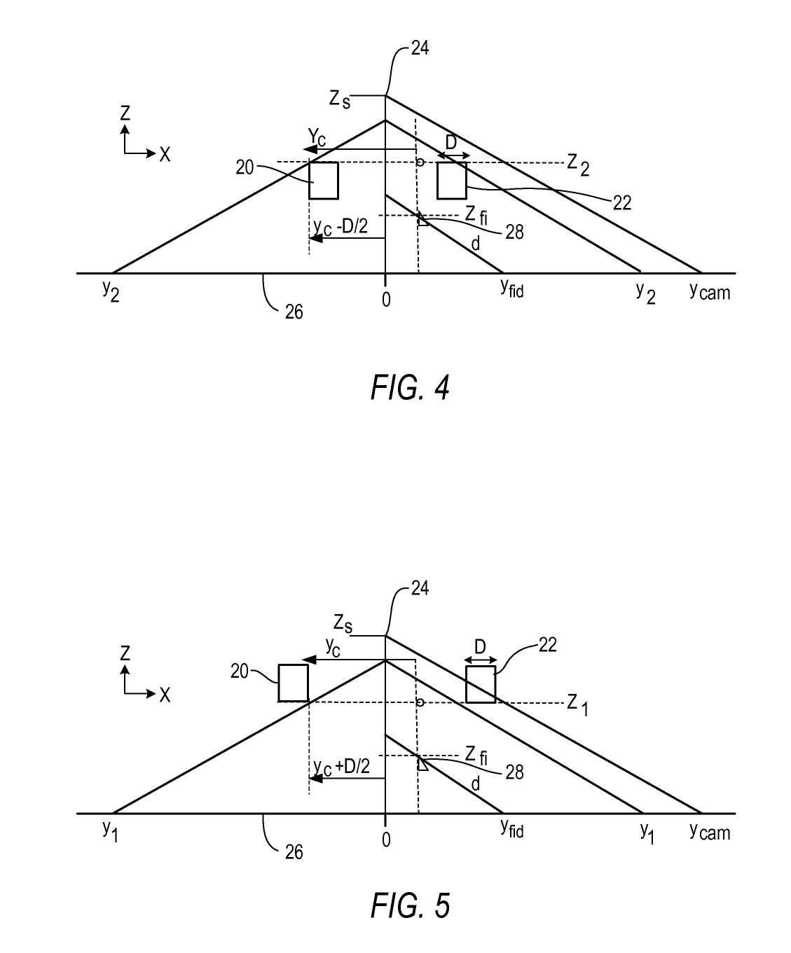

### (2) Parallel Beam Geometry—FIGS. 4 AND 5

For parallel beam geometries the general approach is the same. The equations are slightly different, but are believed to be easily understood by a person of ordinary skill in the art, given the description above, for fan beam geometries. FIG. 4 shows the geometry for finding the top surface of the cylinder, and FIG. 5 shows the geometry for the bottom of the cylinder.

The joint again has diameter D, and its center is located a horizontal distance y_{c} from the reference fiducial, shown as a blue triangle. The fiducial reference is at a vertical height z_{fid}, and is projected to the y-location y_{fid}. The height of the joint corners are z₁ at the bottom of the joint, and z₂ at the top. The imaging ray which intersects a corner hits the detector at y₁ (bottom), or y₂ (top). The location of the detector is referenced at the point y_{cam}. The source is at a vertical height of Zₛ, and y-location 0. Assuming again that the diameter of the barrel is known, the triangulation equations for the parallel beam system are:

y_{cam}z₁+Zₛy_{c}=Zₛ(y₁−y_{fid}+sign(y_{cam})D/2)+y_{cam}z_{fid} Equation 5 (bottom, for FIG. 5)

y_{cam}z₂+Zₛy_{c}=Zₛ(y₂−y_{fid}−sign(y_{cam})D/2)+y_{cam}z_{fid} Equation 6 (top, for FIG. 4)

Again, this linear system is more stable with the addition of prior information D. And again, if the location of the joint is known, then y_{c} can be moved to the right hand side of the equations to decouple the linear system.

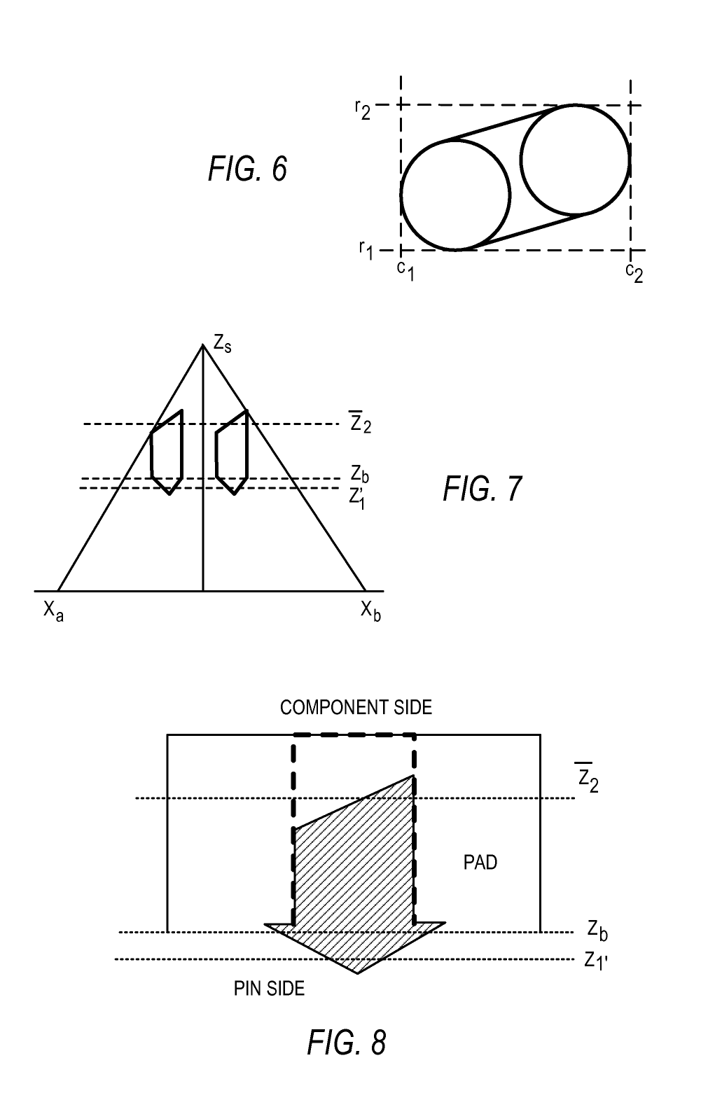

As noted, the triangulation equations take, as inputs, the barrel diameter and the edge locations x₁, x₂, or y₁, y₂ within the projection images. FIG. 6 shows a schematic view of the projection of a cylinder. The edge measurements r₁ (row 1), r₂, c₁ (column 1), and c₂ correspond to the parameters x₁, x₂, or y₁, y₂, depending on whether the system is parallel or fan beam. These measurements must then be converted from pixels to spatial coordinates using system parameters, such as the pixel width, and will vary from system to system.

Cylinder with a Non-Flat Top and Bottom

The above analysis is exact for cylinders, but in practice PTH joints are not perfect cylinders. While the plated-through hole constrains the sides of the joint in the shape of the side of a cylinder, the top and bottom are not constrained. It is, perhaps, only a coincidence if a PTH joint happens to have a top and bottom that are coplanar with the surfaces of the printed circuit board. More realistically, however, most such PTH joints will have shapes that may more accurately be described as cylinders with non-flat tops and bottoms.

As noted above in the example where the cylinder ends were assumed to be flat, we said that the inner surface of the plated-through hole is a first constraint on the shape of the joint, and that the constraint is imposed on the joint by that inner PTH surface. Here, however, we use a different second constraint regarding the ends of the cylinder, i.e., the top and bottom caps of the joint. An example of such a more realistic PTH joint is shown, in cross-section, in FIG. 7. FIG. 7 shows the cross-section of a PTH joint, showing a few artifacts that will often occur in the manufacturing process. The solder on top has wicked up more on the right side. The bottom has a fillet that has wicked around the pin (not shown).

According to common practice in the industry, the top of the part should be taken as the average of the extra wicking on top, e.g., the location z̅₂̅ for measurement. Again according to common industry practice, measurement might not be taken at the bottom of the fillet, or at an intermediate value (for instance, the value labeled z₁′), but rather at the board surface z_{b} at the base of the fillet.

FIG. 8 is a more detailed cross-sectional diagram of the PTH joint of FIG. 7, in which a PC board, having a component side and a pin side, has a plated-through hole that is partially filled with solder, following a manufacturing process. On the component side of the PC board, the solder does not reach the surface of the board. Within the plated-through hole, the solder is wicked up more on the right side than on the left side, but has not reached the component side of the board. The result is a beveled surface, entirely within the plated-through hole. As noted above, the top of the part should be taken as the average of the extra wicking on the right, e.g. z̅₂̅ for measurement.

Likewise, FIG. 8 also shows the wicking around the pin, extending beyond the pin side surface of the PC board. Again, measurement might not be taken at the bottom of the fillet, or at an intermediate value (for instance, the value labeled z₁′), but rather at the board surface z_{b} at the base of the fillet.

Beginning first with the top of the joint, FIG. 7 shows the imaging geometry for the top of this part, and will lend a heuristic explanation to the algorithm's behavior for finding z̅₂̅. Note first that the ray on the right (to the point x_{b}) samples the top-right edge of the joint, which is the higher side, while the left ray samples the lower side (to the point xₐ). Triangulation will average the two measurements, and give the average z-height, z̅₂̅.

For the bottom side of the joint, we want to measure the location of the board surface z_{b}. This measurement is not straightforward, since triangulation will tend to produce some other height, labeled z₁′ in FIG. 8. As shown, z₁′ is a height intermediate between that of the board surface z_{b}, and the farthest extent of the fillet beyond the board surface. However, it is not necessarily the average fillet height, since the solder diameter at z₁′ is not constrained by the barrel. That is, while the image of the fillet in FIG. 7 is shown schematically as being linear, it may in many cases be concave, due to wicking of the solder against the pin. (As noted above, the pin is not shown.)

However, experimentation has shown that there is correlation between the size of the barrel (i.e., the diameter of the cylinder), and the size of the error between z₁′ and z_{b}. This correlation is another piece of prior information which can be used to constrain the solution. Note, incidentally, that there is some difference in the correlation between circular pads and pads of other cross-sectional shapes, such as square pads.

The appropriate correction factor can be computed by fitting a polynomial (linear, quadratic, etc.) to the correlation. In order to compute z_{b}, it is convenient to represent the correction factor by replacing the diameter of the part D with a modified diameter value D′ (an expression representing the fitted polynomial) and then proceed to solve the equations as described above. We might say, more broadly, that the correlation and correction factors are types of statistical data, which may also serve as a known constraint on the feature of interest, and may be employed in embodiments of the invention. Other types of statistical data about the feature of interest may likewise be employed as a constraint.

Another approach that is helpful in improving the accuracy of finding z_{b}, is to average together values of z_{b} from joints which are close neighbors. This helps to average out errors, since it is reasonable to assume that the board height z_{b} is the same for close neighbors.

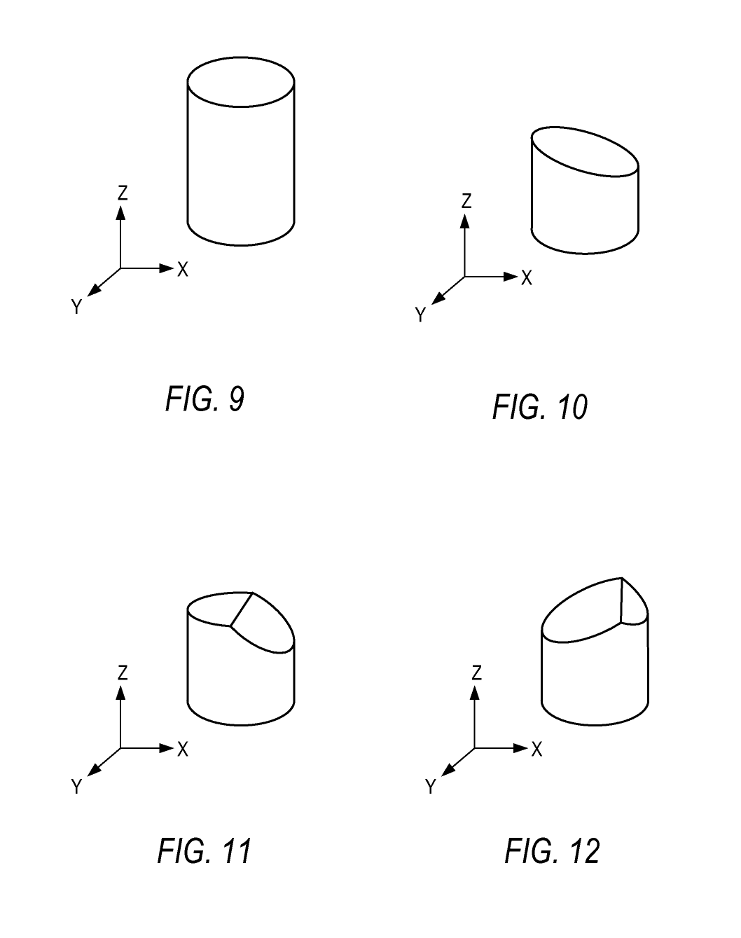

### Additional Forms of Plated-Through Hole Joints—FIGS. 9, 10, 11, AND 12

FIGS. 9-12 show some additional images of features (e.g., plated-through holes), that may be examined using a system, embodying the invention, and employing information that permits simplifying assumptions. These images are in perspective, as they might be observed using a system that makes observations by employing fan beam or parallel beam inspection geometries, and that observes such images resulting from the projections.

FIG. 9 shows an image of a cylinder- or barrel-shaped plated through hole having flat circular top and bottom faces. FIG. 10 shows such a plated through hole, having a flat circular bottom face and a top face that is beveled, so as to produce a slanted, elliptical surface. FIG. 11 shows a plated through hole, having a flat circular bottom face and a top face that is partly flat and circular, and partly beveled. FIG. 12 shows a plated through hole, having a flat circular bottom face and a top face that is similar to that of FIG. 10, except that the beveling does not quite extend fully across the cross-section of the barrel. Rather, an uppermost edge of the through hole is not beveled.

As noted above, plated-through-hole features such as those of FIGS. 10, 11, and 12 may sometimes result from the manufacturing process, for instance when the plated-through hole is not entirely filled with solder.

The features of FIGS. 9-12 have been the subject of experiments, involving simulations that were used to create model parts whose volume was known in advance. The simulations were used to create raw projection images, each with varying levels of asymmetry on top, and a method embodying the invention was used to determine the volume (or average height) of the models. The results show that the average height can be computed quite accurately.

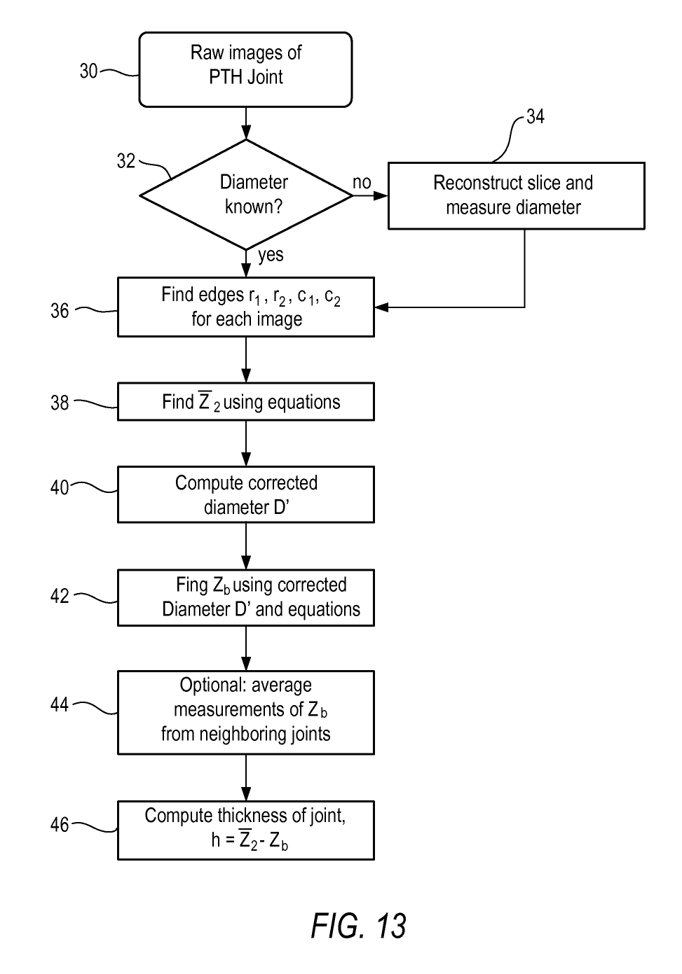

FIG. 13 is a flowchart showing an embodiment of the invention, implemented as a method for examining features of workpieces (e.g., plated-through hole (PTH) solder joints in manufactured PC boards) using photogrammetry employing geometric constraints on the shapes of the features. In keeping with some of the discussion above, it will be assumed that the PTH has a circular cross-section, so that the PTH joint is constrained to a cylindrical shape by the side of the hole, and the faces are not similarly constrained, but may have any of the configurations discussed above, for instance one or more of those of FIGS. 9-12.

Initially, an examination technique is employed (30) to obtain raw images of a PTH joint. As discussed above, this may, for instance, be fan beam or parallel beam reconstruction imaging. Assuming the PTH joint is cylindrical, the circular cross-section will have a given diameter. That diameter may be known or unknown (32). For instance, it may be known based on computer-aided design (CAD) information, or other known information. If it is not known (34), then the raw images are used to reconstruct a slice, which in the case of a cylinder would be a cross-section, taken perpendicular to the axis of the PTH joint. Laminography or tomosynthesis may be used to obtain the slice. The result is a circle, and the measurement of its diameter is then straightforward.

Then, the image is examined, as per FIG. 6, to determine (36) a bounding box, defined in terms of edges r₁, r₂, c₁, and c₂ Those values are then used in a system of equations, for instance appropriate ones of the equations given above, to calculate (38) a suitable value, such as an average value z̅₂̅ for one of the end surfaces of the cylindrical PTH joint (see also FIGS. 7 and 8).

Then, the results of the computations thus far are used to calculate (40) a correction to the diameter of the cylindrical PTH joint. This is in accordance with the discussion, above, of the fillet height error, relative to the height obtained using the triangulation equations.

The correction is then used to compute (42) the height z_{b}, again as discussed above. As discussed, this may include taking an average (44) of measured values z_{b} from multiple joints, which may for instance be nearby on the PC board.

Once the above calculations are completed, it is straightforward to compute (46) a thickness value for the PTH joint from the difference between the end surface values z̅₂̅ and z_{b}, for the opposite ends of the cylindrical joint. The product of that thickness and the area of the circular cross-section (itself a simple function of the diameter), gives the volume of the PTH joint.

While the above-discussed example is predicated on the assumption that the PTH joint may be approximated as a cylinder, other features of different workpieces may be estimated using other geometric formulas appropriate for their three-dimensional volumes, or other shapes. Cubes, rectangular prisms and prisms of other cross-sections, spheres, ellipsoids, and many others may be employed. Where surfaces, or other portions, of such shapes are unconstrained or constrained little enough that values (with or without errors) must be estimated, suitable assumptions may be made. Such assumptions may, for instance, be based on average values such as z̅₂̅, or may be based on assumptions such as that of z_{b}, in which any protrusions, etc., that could add additional volume are disregarded.

A library of constraints, such as those of the library 14 in FIG. 1, may include the geometric formulas for the volumes of various shapes, such as those mentioned above. Formulas for surface that are not fully constrained may be specified separately, For instance, the example of the cylindrical PTH joint, a formula for a cylinder (cross-sectional area times distance between two end surfaces) may be provided, as well as formulas for estimating the ends, either by averaging (such as 38 in FIG. 13) or by truncating protrusions that may be disregarded (42 in FIG. 13).

A constraint within the library may be stand-alone, or may include provisions for considering values from multiple nearby features (for instance, the averaging given on 44 of FIG. 13). Alternatively to merely taking an average, the nearby features may be weighted, for instance by distance from the feature under analysis. Nearby features may be selected for such consideration based on factors other than mere proximity, such as similarity in size, shape, or function, etc., or may be selected on an ad hoc basis by the user for a given workpiece.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A photogrammetry system for examining a feature of interest of a workpiece, the feature of interest having a first constraint, the system comprising:
a library of constraints, including the known constraint of the feature of interest;
a scanner for scanning the workpiece to obtain a scan of the feature of interest,
a selector for selecting the one of the set of constraints from the library; and
an analyzer, coupled to receive the scan of the feature from the scanner and to receive the one of the set of constraints from the selector, the analyzer including a processor for performing an analysis of the scan and the first constraint, to produce an examination result for the feature of interest.

2. A system as recited in claim 1, wherein:
the library of constraints includes geometric constraints; and
the first constraint includes a constraint on a geometric dimension of the feature of interest.

3. A system as recited in claim 1, wherein the library of constraints includes statistical constraints.

4. A system as recited in claim 1, wherein the scanner employs triangulation to obtain the scan of the feature of interest.

5. A system as recited in claim 4, wherein the scanner employs triangulation to determine an average dimension for the feature of interest.

6. A system as recited in claim 1, wherein:
the scanner scans the feature of interest to obtain a dimension of the feature of interest; and
the known constraint of the feature of interest includes a geometric formula for a shape, the formula employing the obtained dimension as a parameter thereof.

7. A system as recited in claim 6, wherein the analyzer performs the analysis of the scan and the one of the set of constraints, employing the obtained dimension of the feature of interest.

8. A system as recited in claim 1, wherein:
the library of constraints further includes a second constraint of the feature of interest; and
the processor of the analyzer performs the analysis of the scan, the first constraint and the second constraint, to produce the examination result for the feature of interest.

9. A system as recited in claim 8, wherein:
the workpiece includes a printed circuit board and the feature of interest includes a solder joint thereon; and
the printed circuit board has a surface which provides the first constraint on the solder joint.

10. A system as recited in claim 9, wherein:
the solder joint is in a plated-through hole of the printed circuit board;
the plated-through hole of the printed circuit board has an inner surface which provides the first constraint on the solder joint; and
the second constraint on the solder joint includes assumptions regarding the shape of the solder joint at the ends of the plated-through hole.

11. A system as recited in claim 1, wherein the examination result of the feature of interest includes a quality of the feature of interest.

12. A system as recited in claim 11, wherein:
the quality of the feature of interest includes a shape of the feature of interest; and
the analyzer performs an analysis of the scan and the first constraint, to produce an examination result including the shape of the feature of interest.

13. A system as recited in claim 12, wherein:
the solder joint has an integrity which is related to its shape;
the examination result includes a measure of the integrity of the solder joint, based on the shape of the solder joint.

14. A method for doing an x-ray examination of a feature of interest on a workpiece, the method comprising:
identifying a simplifying assumption for the feature of interest;
performing a scan of the workpiece to obtain image information for the feature of interest; and
analyzing the image information, the analysis utilizing the simplifying assumption.

15. A method as recited in claim 14, wherein:
the workpiece includes a printed circuit board having a plated-through hole;
the feature of interest includes a solder joint within the plated-through hole; and
the performing a scan includes
(1) determining the diameter of the through-hole by either
a) using CAD or other known data if available, or
b) reconstructing a cross-sectional slice of the joint using one of laminography and tomosynthesis inside the plated-through hole, and
(2) measuring the diameter directly.

16. A method as recited in claim 14, wherein:
the identifying and the performing a scan are done for multiple features of interest; and
the analyzing includes using an average of the image information from the multiple features of interest.
